(19) United States
(12) Patent Application Publication
(10) Pub. No.: US 2020/0226588 A1
(43) Pub. Date: Jul. 16, 2020

(54) CURRENCY CHANGE MANAGEMENT SYSTEM

(71) Applicant: Koinage LLC, Franklin, OH (US)

(72) Inventor: Chika Okere, Franklin, OH (US)

(73) Assignee: Koinage LLC, Franklin, OH (US)

(21) Appl. No.: 16/741,103

(22) Filed: Jan. 13, 2020

Related U.S. Application Data
(60) Provisional application No. 62/792,013, filed on Jan. 14, 2019.

(51) Int. Cl. G06Q 20/36; G06Q 20/20; G06Q 20/38; G06K 19/06; G06Q 20/32

(52) U.S. Cl. CPC G06Q 20/3674; G06Q 20/20; G06Q 20/3678; G06Q 20/3278; G06K 19/06028; G06K 19/06037; G06Q 20/3829

(57) ABSTRACT

A method, point of sale (POS) electronic device and user electronic device enable combining tangible currency and digital money in a retail or service provider transaction to avoid an inconvenience of carrying and dispensing coins. The POS electronic devices receive a purchase price for a transaction and a value of cash received from a purchaser. A controller of the POS electronic devices determines an amount of change as the difference between the value of cash received and the purchase price. The POS electronic devices create a self-authenticating transaction record of the amount of change for storage in an electronic petty cash account on the user electronic device of the purchaser. The self-authenticating transaction record and the electronic petty cash account need not be associated with any particular person to enhance personal privacy.

### CROSS-REFERENCE TO RELATED APPLICATIONS

The present application for patent claims priority to U.S. Provisional Application No. 62/792,013, entitled “CURRENCY CHANGE MANAGEMENT SYSTEM” filed 14 Jan. 2019, which is hereby expressly incorporated by reference herein for all purposes.

### FIELD OF THE INVENTION

The present disclosure generally relates consumer financial transactions and more particularly pertains to digital money management at a point of sale device.

### BACKGROUND OF THE INVENTION

Retail and other financial transactions are increasingly accomplished without use of traditional paper and coin currency. Digital credit and debit accounts are widely used to transfer funds from one electronic associated with a purchaser to another account associated with the seller or service provider. The accounts provide electronic records that facilitate tracking and auditing of transactions by particular persons, either corporate or human. Although such systems provide a great deal of productivity and efficiency, credit or debit-based transactions can jeopardize personal privacy. Legal transactions can be associated with social stigmas or divulge too much about a person that third-parties should not have access to. Such person data is all too frequently disclosed inadvertently or maliciously to third parties, such as by entities that enable identity theft or fraudulent transactions.

For such considerations, use of cash currency is still a logical and traditional approach to effecting transactions. In addition, in some instances both of a consumer or a retailer are not in a position to use a credit or debit account, choosing to transact on a cash basis instead. Anonymity of the consumer is still possible by using currency. However, with inflation over time, the buying power of currency such as coins is reduced. In order to complete a transaction, a consumer and a point of sale (POS) system has to handle significant quantities of coins. Carry and dispensing coins can be an inconvenience. It can be contemplated that with further inflation, small value paper currencies will similarly become inconvenient when making change.

### SUMMARY OF THE INVENTION

In one aspect, the present disclosure provides a method of combining tangible currency and digital money in a retail transaction. In one or more embodiments, the method includes receiving, at a point of sale (POS) electronic device, a purchase price for a transaction and a value of cash received from a purchaser. The method includes determining an amount of change as the difference between the value of cash received and the purchase price. The method includes creating a self-authenticating transaction record of the amount of change for storage in an electronic petty cash account on a user electronic device of the purchaser. The self-authenticating transaction record and the electronic petty cash account are not associated with any particular person to preserve personal privacy.

In another aspect, the present disclosure provides a POS electronic device includes at least one input device and at least one output device. A controller is communicatively coupled to the at least one input device and the at least one output device. The controller includes a processor that executes program code to enable the POS electronic device to: (i) receive, via the at least one input device, a purchase price for a transaction and a value of cash received from a purchaser; (ii) determine an amount of change as the difference between the value of cash received and the purchase price; and (iii) create, via the at least one output device, a self-authenticating transaction record of the amount of change for storage in an electronic petty cash account on a user electronic device of the purchaser. The self-authenticating transaction record and the electronic petty cash account are not associated with any particular person to preserve personal privacy.

In an additional aspect, the present disclosure provides a user electronic device that includes a memory containing an electronic petty cash account and an application, at least one input device, and at least one output device. A controller is communicatively coupled to the memory, the at least one input device and the at least one output device. The controller includes a processor that executes program code to enable the POS device to: (i) present, via the at least one output device, an identifier for the electronic petty cash account for receipt by a POS device; (ii) receive a self-authenticating transaction record of the amount of change from a transaction; (iii) calculate a balance for the electronic petty cash account based on the amount of change in the self-authenticating transaction record; and (iv) store the self-authenticating transaction record and the balance in the electronic petty cash account. The self-authenticating transaction record and the electronic petty cash account are not associated with any particular person to preserve personal privacy.

These and other features are explained more fully in the embodiments illustrated below. It should be understood that in general the features of one embodiment also may be used in combination with features of another embodiment and that the embodiments are not intended to limit the scope of the invention.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 illustrates a block diagram of a communication system including, according to one or more embodiments;

FIG. 2, according to one or more embodiments; and

FIG. 3

FIG. 4 illustrate a flow diagram of a method of - -, according to one or more embodiments.

### DETAILED DESCRIPTION

A method, point of sale (POS) electronic device, and user electronic device enable combining tangible currency and digital money in a retail or service provider transaction to avoid an inconvenience of carrying and dispensing coins. Yet, a user is able to retain the privacy benefits of a fully cash transaction. The POS electronic devices receive a purchase price for a transaction and a value of cash received from a purchaser. A controller of the POS electronic devices determines an amount of change as the difference between the value of cash received and the purchase price. The POS electronic devices create a self-authenticating transaction record of the amount of change for storage in an electronic petty cash account on the user electronic device of the purchaser. The self-authenticating transaction record and the electronic petty cash account need not be associated with any particular person to enhance personal privacy.

“KoinAge” system is a virtual coin manager that allows consumers to avoid carrying coins resulting from cash transaction. Change is retained in a virtual piggy bank and accessed as needed via a mobile application. Problems addressed include: (i) avoiding discomfort in carrying large amount of coin; (ii) lack of purchasing power of coins in the US due to inflation; and (iii) discarding of coins that are perceived to have no value.

Retailer(s) have a KoinAge system integrated into point of sale (POS) systems. A POS cash transaction is entered into by an end user such as a customer or consumer having a KoinAge mobile application (app) at a retailer location having a POS system. The cash transaction results in an amount of change that corresponds to coins amounting to less than paper currency that is on hand. POS system determines whether the consumer consents to receiving the change in form of a deposit to a KoinAge account used by the consumer. In response to receiving or determining tacit or pre-existing consent, the KoinAge account embodied at least in part on the mobile app executed by a mobile electronic device carried by the consumer. Funds are immediately added and included in a balance of the KoinAge account. POS system can issue paper receipts and confirmation documentation for record and archival purposes for either the retailer or the consumer. Consumers can choose to keep this change in a virtual piggy bank from which they can make payments for other purchases using a mobile application. Some of the planned payment acceptance systems include: (i) vending machines; (ii) tolls; and (iii) parking meters.

In collaboration with popular stores, the KoinAge system can be incorporated into existing payment systems. Consumers will be asked if the consumer would like to save or add their change to their KoinAge account. Once the consumer agrees, the payment system applies the change amount to the account of the customer by scanning the application on the mobile phone. The mobile application keeps a record of all transactions, balances, etc. The consumer is able to access funds as needed to pay for items approved for the KoinAge payment system.

In one or more embodiments, a charitable donation can be made directly in lieu of the cash change due, or at least a portion of the change (e.g. that portion comprising low value coins). In one or more embodiments, a coupon can be made directly in lieu of the cash change due, or at least a portion of the change. A coupon may be redeemable for a free product, a discount on a product, or for a discount on purchase of combination products.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments but no other embodiments.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that terms is utilized.

The description of the illustrative embodiments can be read in conjunction with the accompanying figures. Embodiments incorporating teachings of the present disclosure are shown and described with respect to the figures presented herein.

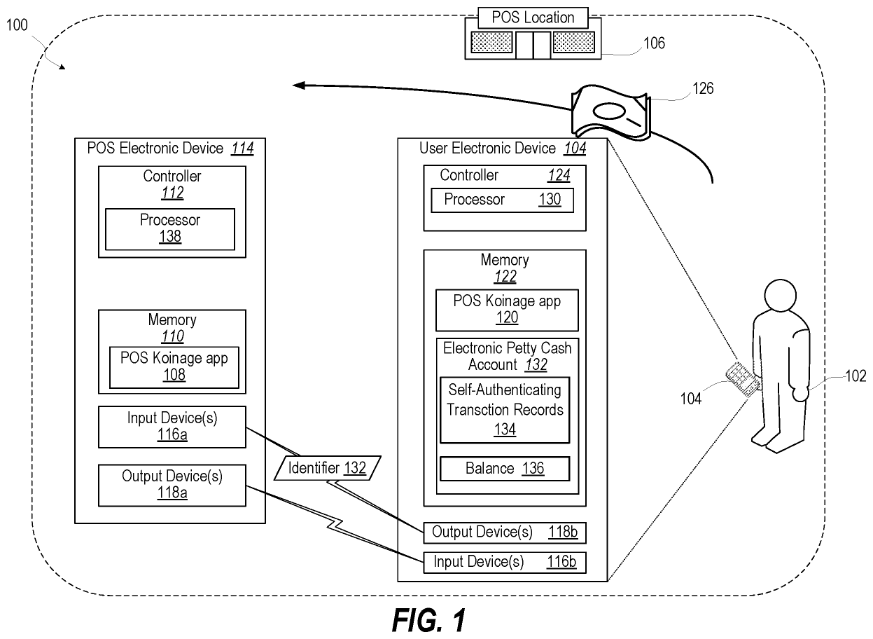

FIG. 1 is diagram of enhanced cash exchange ecology 100 wherein a user 102 can carry a user electronic device 104 in lieu of carrying or receiving currency coins to retail or service provider location 106. A point of sale (POS) KoinAge application 108 in memory 110 and executed by a controller 112 of a POS device 114 interacts via respective input device(s) 116a, 116b and output device(s) 118a, 118b with a consumer KoinAge application 120 in memory 122 and executed by a controller 124 of the user electronic device 104. The direct or indirect interaction between POS and consumer KoinAge applications 108, 120 provides the benefits of personal privacy and other convenient aspects of using cash 126 for a transaction without the inconvenience of dealing with small monetary amounts of coins or even small currency bills.

User electronic device 104 includes an electronic petty cash account 128 that is maintained by consumer Koinage application 120. The controller 124 of user electronic device 104 is communicatively coupled to the memory 122, the input device(s) 116b, and the output device(s) 118b. Controller 124 includes a processor 130 that executes program code such as consumer Koinage application 120 to enable the user electronic device 104 to provide certain functionality. User electronic device 104 presents, via the at least one output device 118b, an identifier 132 for the electronic petty cash account 128 for receipt by a POS electronic device 114. User electronic device 104 receives, via the at least one input device 116b, a self-authenticating transaction record 134 of the amount of change from a transaction. Controller 124 calculates a balance 136 for the electronic petty cash account 132 based on the amount of change in the self-authenticating transaction record 134. User electronic device 104 stores the self-authenticating transaction record 134 and the balance 136 in the electronic petty cash account 132. The self-authenticating transaction record 134 and the electronic petty cash account 132 are not associated with any particular person to ensure the personal privacy of user 102. User electronic device 104 can communicate the balance 136 to POS electronic device 114 to initiate transfer of some of the balance 136 to cover an insufficient amount of currency 126.

Similarly, controller 112 of POS electronic device 114 is communicatively coupled to memory 110, the at least one input device 116a and the at least one output device 118a. Controller 112 includes a processor 138 that executes program code such as POS Koinage application 108 to enable the POS electronic device 114 to provide certain functionality. POS electronic device 114 receives, via the at least one input device 118a, a purchase price for a transaction and a value of cash received from a purchaser such as user 102. Controller 112 determines an amount of change as the difference between the value of cash received and the purchase price. Controller 112 creates, via the at least one output device 118a, the self-authenticating transaction record 134 of the amount of change for storage in an electronic petty cash account 132 on the user electronic device 104 of the purchaser (user 102).

In one or more embodiments, the controller 112 creates the self-authenticating transaction record 134 in response to identifying, the via the application 120 executed on the user electronic device 104 of the purchaser, an identity the electronic petty cash account 132 maintained on the user electronic device 104. In particular embodiments, the controller 112 creates the self-authenticating transaction record 132 by: (i) assigning a unique transaction code to the self-authenticating transaction record 132; and (ii) encrypting the unique transaction code with key assigned to at least the POS electronic device 114. In particular embodiments, the controller 112 creates the self-authenticating transaction record 132 by creating block chain protected crypto currency transaction.

In one or more embodiments, the controller 112 enables the POS electronic device 114 to: (i) determine that the amount of change is a negative value; (ii) authenticate a balance 136 in the electronic petty cash account 132 sufficient to cover the negative value based on authenticating one or more unique transaction codes; and (iii) create the self-authenticating transaction record 134 that debits the electronic petty cash account 132 to satisfy the negative value.

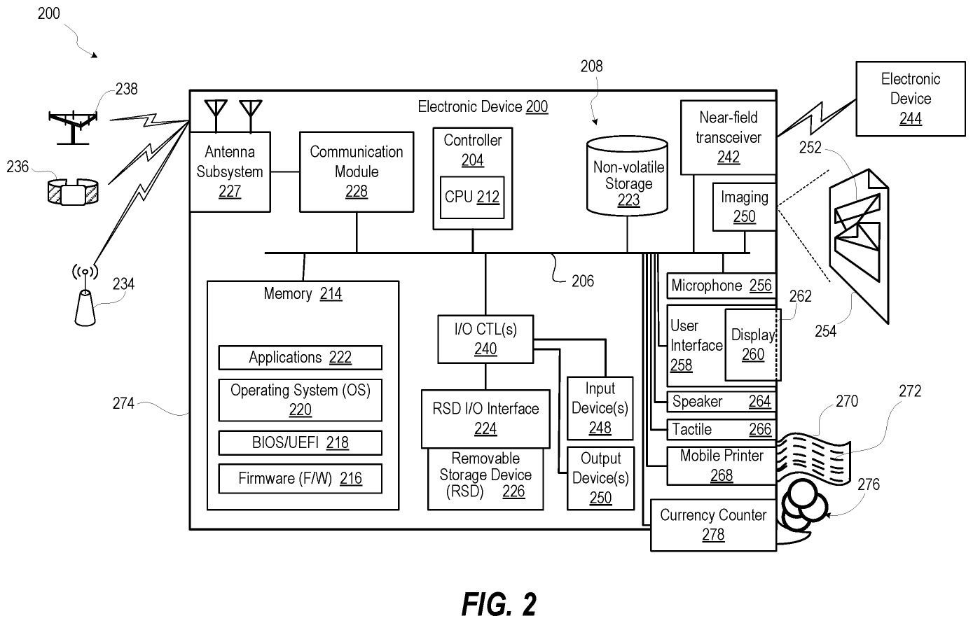

Turning now to FIG. 2, there is depicted a block diagram representation of an example electronic device 200 within which several of the features of the disclosure can be implemented. Electronic device 200 can perform the functions of POS electronic device 114 or user electronic device 104 (FIG. 1). In one or more embodiments, electronic device 200 incorporates wireless communication capabilities to operate as a wireless communication device. Communication device 200 can be one of a host of different types of devices, including but not limited to, a mobile cellular phone or smart-phone, a laptop, a net-book, an ultra-book, a networked smart watch or networked sports/exercise watch, and/or a tablet computing device or similar device that can include wireless communication functionality. As a device supporting wireless communication, communication device 200 can be one of, and also be referred to as, a system, device, subscriber unit, subscriber station, mobile station (MS), mobile, mobile device, remote station, remote terminal, user terminal, terminal, user agent, user device, cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. These various devices all provide and/or include the necessary hardware and software to support the various wireless or wired communication functions as part of a communication system 202. Communication device 200 can also be an over-the-air link in communication system 202 that can be intended to be portable or hand-held or for which a user can move into close proximity. Examples of such communication devices include a wireless modem, an access point, a repeater, a wirelessly-enabled kiosk or appliance, a femtocell, a small coverage area node, and a wireless sensor, etc.

Referring now to the specific component makeup and the associated functionality of the presented components, controller 204 can be an integrated circuit (IC) that connects, via a plurality of bus interconnects 206, to a plurality of functional components 208 of communication device 200. Controller 204 can include one or more programmable microprocessors, such as processor 212, which may both be integrated into a single processing device, in some embodiments. controller 204 controls the communication, user interface, and other functions and/or operations of communication device 200. These functions and/or operations thus include, but are not limited to including, application data processing and signal processing. Communication device 200 may use hardware component equivalents such as special purpose hardware, dedicated processors, general purpose computers, microprocessor-based computers, micro-controllers, optical computers, analog computers, dedicated processors and/or dedicated hard wired logic. Connected to controller 204 is memory 214, which can include volatile memory and/or non-volatile memory. Memory 214 can include therein a plurality of modules, including firmware (F/W) 216, UEFI BIOS platform 218, operating system (O/S) 220 and application(s) 222. The various software and/or firmware modules have varying functionality when their corresponding program code is executed by controller 204 or other processing devices within electronic device 200. The Unified Extensible Firmware Interface (UEFI) is a specification that defines a software interface between an operating system and platform firmware. UEFI is meant to replace the Basic Input/Output System (BIOS) firmware interface, present in a majority of conventional PC-compatible personal computers. In practice, most UEFI images provide legacy support for BIOS services. UEFI can support remote diagnostics and repair of computers, even without another operating system. Memory 214 may be augmented by on-device data storage 223. Also connected to controller 204 is removable storage device (RSD) input/output (I/O) interface 224 that receives an RSD 226 for additional storage.

According to the illustrative embodiment, communication device 200 supports wireless communication over an antenna subsystem 227 via a communication module 228. For example, communication device 200 may support communication protocols and transceiver radio frequencies appropriate for a wireless local area network (WLAN), illustrated as node 234. Communication device 200 can communicate over a personal access network (PAN) with devices such as a smart watch 236. Communication device 200 can communicate with a radio access network (RAN) 238 that is part of a wireless wide area network (WWAN). In certain embodiments, communication device 200 may also support a hardwired local access network (LAN) (not shown) or peripheral devices via an I/O controller 240. Communication device 200 can also communicate via near field communication (NFC) device 242 to another electronic device 244 such as a vending kiosk for fee-based converting bulk currency coins into a consolidated payment.

Communication device 200 includes input and output devices 246, 248 for enabling a user to interact and/or to interact with another electronic device 244. For example, an image capturing device, such as a camera 250, can receive displayed or printed identifiers 252 in the form of alphanumeric codes, one-dimensional barcodes, and two-dimensional barcodes from printed substrate 254 or a display of another electronic device 244. Microphone 256 receives user audible inputs. User interface device 258 can present visual or tactile outputs as well as receive user inputs. In one example, user interface device 258 can include a touch screen 260 that is embedded within or associated with a display 262. An audio speaker 264 can augment or provide alternate presentation of the visual or tactile outputs of user interface device 258. A tactile control 266 can provide an interface such as for braille reading or manual inputs. A mobile printer 268 can print identifiers 270 in the form of alphanumeric codes, one-dimensional barcodes, and two-dimensional barcodes from printed substrate 272. Communication device 200 can be wholly or substantially encompassed by an enclosure 274. In one or more embodiments, communication device 200 can be a distributed system of wireless or wired links or a component subsystem incorporated into a larger assembly or system.

In one or more embodiments, the controller 204 identifies the electronic petty cash account 132 (FIG. 1) on the other user electronic device 244 via the at least one input device 248 by scanning an authenticating code generated by the other electronic device 244 on a selected one of: (i) a display of the user electronic device comprising a mobile electronic device; and (ii) a printed substrate 254.

In one or more embodiments, the controller 204 identifies the electronic petty cash account 132 (FIG. 1) on the other user electronic device 244 via the at least one input device 248 by communicating with a selected one of: (i) a personal access network (PAN) interface; and (ii) near-field communication interface of the electronic device 200.

In one or more embodiments, the controller 204 via the at least one output device 250 such as mobile printer 268 prints the self-authenticating transaction record as a selected one of: (i) a one-dimensional bar code; (ii) a two-dimensional bar code; and (iii) an alphanumeric code for a purchaser to enter into the other electronic device 244.

In one or more embodiments, electronic device 200 is an automated currency counting machine that receives and counts currency 276 in a currency counting subsystem 278 and identifies the purchase price as a fee for converting the currency 276 into a consolidated form.

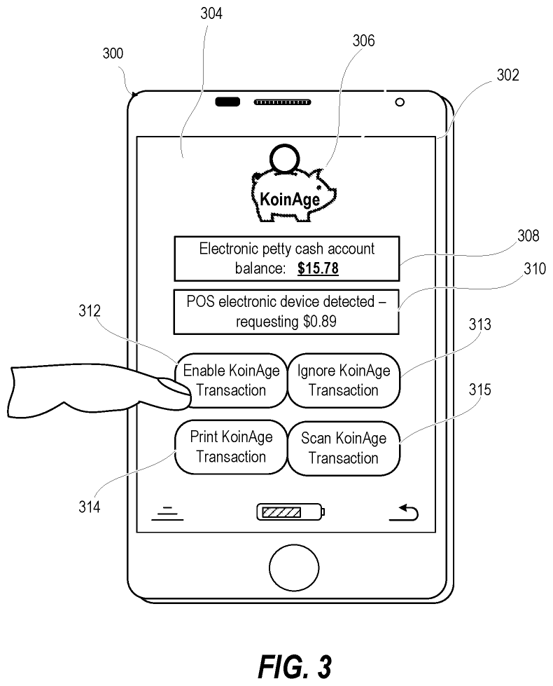

FIG. 3 is a front view illustrating an electronic device 300 having a user interface 302 presented on a touch screen display 304 that can perform one of a POS function and a consumer function. With regard to the former, small businesses are increasingly using mobile smartphones and tablets to serve as a POS device. As such, a cash drawer is provided as a manual apparatus or a peripheral device. Keeping a supply of coins can be inconvenient. With regard to the latter, a consumer can view information and interact with affordances presented by a KoinAge application 306. Information can include an electronic petty cash account balance 308 and opportunities to engage a POS electronic device 310. Affordance include a button 312-315 respectively to (i) enable a KoinAge transaction; (ii) ignore a KoinAge transaction; (iii) print a KoinAge transaction; and (iv) scan a KoinAge transaction.

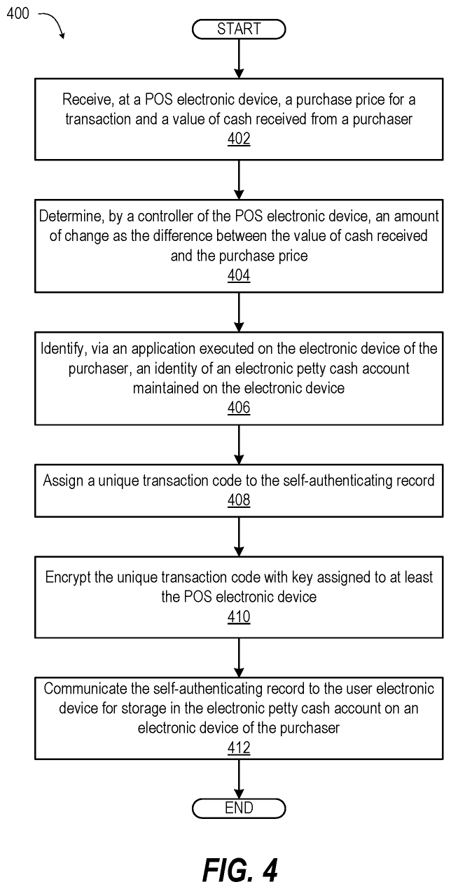

FIG. 4 is a flow diagram illustrating a method 400 of combining tangible currency and digital money in a retail transaction. in one or more embodiments, method 400 includes receiving, at a POS electronic device, a purchase price for a transaction and a value of cash received from a purchaser (block 402). Method 400 includes determining, by a controller of the POS electronic device, an amount of change as the difference between the value of cash received and the purchase price (block 404). Method 400 includes identifying, via an application executed on the electronic device of the purchaser, an identity of an electronic petty cash account maintained on the electronic device (block 406).

In one or more embodiments, method 400 includes identifying the application executed on the electronic device comprises scanning an authenticating code generated by the electronic device on a selected one of: (i) a display of the electronic device comprising a mobile electronic device; and (ii) a printed substrate.

In one or more embodiments, method 400 includes identifying the application executed on the user electronic device comprises communicating with a selected one of: (i) a personal access network (PAN) interface; and (ii) near-field communication interface of the user electronic device.

Method 400 includes assigning a unique transaction code to the self-authenticating transaction record (block 408). Method 400 includes encrypting the unique transaction code with key assigned to at least the POS electronic device (block 410). For example, other POS electronic devices affiliated with the POS electronic device are able to identify the origin of the transaction based on public key associated with the POS electronic device. Method 400 includes communicating the self-authenticating transaction record to the user electronic device for storage in the electronic petty cash account on an electronic device of the purchaser (block 412). The self-authenticating transaction record and the electronic petty cash account are not associated with any particular person in order to preserve personal privacy.

In one or more embodiments, method 400 includes communicating with the user electronic device directly to provide the self-authenticating transaction record and the electronic petty cash account. In one or more embodiments, method 400 includes communicating with the user electronic device indirectly by printing the self-authenticating transaction record as a selected one of: (i) a one-dimensional bar code; (ii) a two-dimensional bar code; and (iii) an alphanumeric code for a purchaser to enter into the electronic device. Then method 400 ends.

With a positive balance in the electronic petty cash account, method 400 can continue with a subsequent transaction that debits the electronic petty cash account. For example, method 400 can include: (i) determining that the amount of change is a negative value; (ii) authenticating a balance in the electronic petty cash account sufficient to cover the negative value based on authenticating one or more unique transaction codes; and (iii) creating the self-authenticating transaction record that debits the electronic petty cash account to satisfy the negative value.

In one or more embodiments, method 400 includes receiving, at the POS electronic device, the purchase price for a transaction and the value of cash received from the purchaser comprises, by an automated currency counting machine. The automated currency counting machine receives currency, counts the currency, and identifies the purchase price as a fee for converting the currency into a consolidated form.

In the above described flow chart of FIG. 4, the method(s) may be embodied in an automated control system that performs a series of functional processes. In some implementations, certain steps of the methods are combined, performed simultaneously or in a different order, or perhaps omitted, without deviating from the scope of the disclosure. Thus, while the method blocks are described and illustrated in a particular sequence, use of a specific sequence of functional processes represented by the blocks is not meant to imply any limitations on the disclosure. Changes may be made with regards to the sequence of processes without departing from the scope of the present disclosure. Use of a particular sequence is therefore, not to be taken in a limiting sense, and the scope of the present disclosure is defined only by the appended claims.

It must be noted that, as used in this specification and the appended claims, the singular forms “a,” “an” and “the” include plural referents unless the content clearly dictates otherwise. Thus, for example, reference to a “colorant agent” includes two or more such agents.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

As will be appreciated by one having ordinary skill in the art, the methods and compositions of the invention substantially reduce or eliminate the disadvantages and drawbacks associated with prior art methods and compositions.

It should be noted that, when employed in the present disclosure, the terms “comprises,” “comprising,” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof.

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

While it is apparent that the illustrative embodiments of the invention herein disclosed fulfill the objectives stated above, it will be appreciated that numerous modifications and other embodiments may be devised by one of ordinary skill in the art. Accordingly, it will be understood that the appended claims are intended to cover all such modifications and embodiments, which come within the spirit and scope of the present invention.

What is claimed is:

1. A method of combining tangible currency and digital money in a retail transaction, the method comprising:
receiving, at a point of sale (POS) electronic device, a purchase price for a transaction and a value of cash received from a purchaser;
determining an amount of change as the difference between the value of cash received and the purchase price; and
creating a self-authenticating transaction record of the amount of change for storage in an electronic petty cash account on a user electronic device of the purchaser, wherein the self-authenticating transaction record and the electronic petty cash account are not associated with any particular person.

2. The method of claim 1, wherein creating the self-authenticating transaction record is in response to identifying, via the application executed on the user electronic device of the purchaser, the electronic petty cash account maintained on the user electronic device.

3. The method of claim 2, wherein creating the self-authenticating transaction record comprises:
assigning a unique transaction code to the self-authenticating transaction record; and
encrypting the unique transaction code with key assigned to at least the POS electronic device.

4. The method of claim 3, wherein creating the self-authenticating transaction record comprises creating block chain protected crypto currency transaction.

5. The method of claim 2, further comprising:
determining that the amount of change is a negative value;
authenticating a balance in the electronic petty cash account sufficient to cover the negative value based on authenticating one or more unique transaction codes; and
creating the self-authenticating transaction record that debits the electronic petty cash account to satisfy the negative value.

6. The method of claim 2, wherein identifying the application executed on the user electronic device comprises scanning an authenticating code generated by the user electronic device on a selected one of: (i) a display of the user electronic device comprising a mobile electronic device; and (ii) a printed substrate.

7. The method of claim 2, wherein identifying the application executed on the user electronic device comprises communicating with a selected one of: (i) a personal access network (PAN) interface; and (ii) near-field communication interface of the user electronic device.

8. The method of claim 1, further comprising printing the self-authenticating transaction record as a selected one of: (i) a one-dimensional bar code; (ii) a two-dimensional bar code; and (iii) an alphanumeric code for a purchaser to enter into the user electronic device.

9. The method of claim 1, wherein receiving, at the POS electronic device, the purchase price for a transaction and the value of cash received from the purchaser comprises, by an automated currency counting machine:
receiving currency;
counting the currency; and
identifying the purchase price as a fee for converting the currency into a consolidated form.

10. A point of sale (POS) electronic device comprising:
at least one input device;
at least one output device;
a controller communicatively coupled to the at least one input device and the at least one output device and comprising a processor that executes program code to enable the POS electronic device to:
receive, via the at least one input device, a purchase price for a transaction and a value of cash received from a purchaser;
determine an amount of change as the difference between the value of cash received and the purchase price; and
create, via the at least one output device, a self-authenticating transaction record of the amount of change for storage in an electronic petty cash account on a user electronic device of the purchaser, wherein the self-authenticating transaction record and the electronic petty cash account are not associated with any particular person.

11. The POS electronic device of claim 10, wherein the controller creates the self-authenticating transaction record in response to identifying, the via the application executed on the user electronic device of the purchaser, an identity the electronic petty cash account maintained on the user electronic device.

12. The POS electronic device of claim 11, wherein the controller creates the self-authenticating transaction record by:
assigning a unique transaction code to the self-authenticating transaction record; and
encrypting the unique transaction code with key assigned to at least the POS electronic device.

13. The POS electronic device of claim 11, wherein the controller creates the self-authenticating transaction record by creating block chain protected crypto currency transaction.

14. The POS electronic device of claim 11, wherein the controller enables the POS electronic device to:
determine that the amount of change is a negative value;
authenticate a balance in the electronic petty cash account sufficient to cover the negative value based on authenticating one or more unique transaction codes; and
create the self-authenticating transaction record that debits the electronic petty cash account to satisfy the negative value.

15. The POS electronic device of claim 11, wherein the controller identifies the application executed on the user electronic device via the at least one input device by scanning an authenticating code generated by the user electronic device on a selected one of: (i) a display of the user electronic device comprising a mobile electronic device; and (ii) a printed substrate.

16. The POS electronic device of claim 11, wherein the controller identifies the application executed on the user electronic device via the at least one input device by communicating with a selected one of: (i) a personal access network (PAN) interface; and (ii) near-field communication interface of the user electronic device.

17. The POS electronic device of claim 10, wherein the controller via the at least one output device prints the self-authenticating transaction record as a selected one of: (i) a one-dimensional bar code; (ii) a two-dimensional bar code; and (iii) an alphanumeric code for a purchaser to enter into the user electronic device.

18. The POS electronic device of claim 10, wherein the POS electronic device comprises an automated currency counting machine that: (i) receives currency; (ii) counts the currency; and (iii) identifies the purchase price as a fee for converting the currency into a consolidated form.

19. A user electronic device comprising:
a memory containing an electronic petty cash account and an application;
at least one input device;
at least one output device;
a controller communicatively coupled to the memory, the at least one input device, and the at least one output device and comprising a processor that executes program code to enable the user electronic device to:
present, via the at least one output device, an identifier for the electronic petty cash account for receipt by a point of sale (POS) electronic device;
receive, via the at least one input device, a self-authenticating transaction record of the amount of change from a transaction;
calculate a balance for the electronic petty cash account based on the amount of change in the self-authenticating transaction record; and
store the self-authenticating transaction record and the balance in the electronic petty cash account, wherein the self-authenticating transaction record and the electronic petty cash account are not associated with any particular person.

20. The user electronic device of claim 19, wherein the controller enables the user electronic device to:
communicate the balance of the electronic petty cash account to the POS electronic device; and
create the self-authenticating transaction record that debits the electronic petty cash account to satisfy a negative value of the amount of change.
